SEQUENCE LISTING (3 sequences)

SEQ ID NO: 1 - DNA, 8 bp, Artificial Sequence
  Exemplary sequence from drawings 1 and 2
attgacac

SEQ ID NO: 2 - DNA, 12 bp, Artificial Sequence
  Exemplary sequence from drawings 1 and 2
ccaagtctcaag

SEQ ID NO: 3 - DNA, 11 bp, Artificial Sequence
  Exemplary sequence from drawings 1 and 2
ccaatgtgaca

(19) United States
(12) Patent Application Publication
(10) Pub. No.: US 2009/0118129 A1
(43) Pub. Date: May 7, 2009

(54) VIRTUAL READS FOR READLENGTH ENHANCEMENT

(75) Inventor: Stephen Turner, Menlo Park, CA (US)

Correspondence Address: QUINE INTELLECTUAL PROPERTY LAW GROUP, P.C., P O BOX 458, ALAMEDA, CA, 94501, US

(73) Assignee: Pacific Biosciences of California, Inc., Menlo Park, CA (US)

(21) Appl. No.: 12/212,106

(22) Filed: Sep. 17, 2008

Related U.S. Application Data
(60) Provisional application No. 60/995,732, filed on Sep. 28, 2007.

(51) Int. Cl. C40B 20/02; C40B 20/00; C40B 20/08; C40B 50/18; C40B 40/08; C40B 60/10

(52) U.S. Cl. 506/3; 506/2; 506/6; 506/32; 506/17; 506/38

(57) ABSTRACT

Methods arrays and systems that facilitate contig assembly during nucleic acid sequencing are provided. Geographical locations of analyte molecules on an array are correlated with subsequence relationships within larger nucleic acids.

### CROSS-REFERENCE TO RELATED APPLICATIONS

This application claims priority to and benefit of U.S. Ser. No. 60/995,732, filed Sep. 28, 2007, by Turner, entitled “VIRTUAL READS FOR READLENGTH ENHANCEMENT.” This prior application is incorporated herein by reference in its entirety.

### FIELD OF THE INVENTION

This invention is in the field of nucleic acid sequencing, e.g., contig assembly.

### BACKGROUND OF THE INVENTION

Nucleic acid sequencing is ubiquitous to molecular biology and molecular medicine. For example, the initial sequencing of the human genome (Venter et al. (2001) “The sequence of the human genome,” Science 291: 1304-1351; Lander et al. (2001) “Initial sequencing and analysis of the human genome” Nature 409: 860-921) and subsequent completion of the Human Genome Project in 2003 (International Human Genome Sequencing Consortium (2004) “Finishing the euchromatic sequence of the human genome,” Nature 431:931-945) signaled the beginning of a new era of biomedical research and clinical practice in which the genetic basis for a variety of biological processes could be studied in unprecedented detail. The current goals of genetic research that use genomic information include determining the hereditary factors in disease, developing new methods to detect disease and to guide therapy (e.g., van de Vijver et al. (2002) “A gene-expression signature as a predictor of survival in breast cancer,” New England Journal of Medicine 347:1999-2009), as well as accelerating drug discovery by providing many new targets for therapy.

To pursue these goals, it is useful for scientists and clinicians to compare genetic differences between species, as well as between individuals within species, often taking as many individual genomes (or parts thereof) into account as are available. However, the cost of fully sequencing the genome of an individual are still prohibitive for most applications. Indeed, to date, only a single human individual (J. Craig Venter) has had most of his entire diploid genome sequenced (Levy et al. (2007) “The Diploid Genome Sequence of an Individual Human” PLoS Biology Vol. 5, No. 10, e254 doi:10.1371/journal.pbio.0050254). The cost of nucleic acid sequencing, combined with the clear value of genomic and other sequence information, creates a strong need for improved sequencing techniques, to generate useful sequence information for more species and individuals.

Goals for sequencing technologies include increasing throughput, lowering reagent and labor costs and improving accuracy. For a relatively recent review of current sequencing technologies, see, e.g., Chan (2005) “Advances in Sequencing Technology” (Review) Mutation Research 573: 13-40. A commonly stated goal of current sequencing technology development efforts is to bring the cost for sequencing (or at least resequencing) a genome down to about $1,000. If sequencing costs can be brought down to this level, it will be possible to analyze genetic variation in detail for species and individuals, providing a more rational basis for personalized medicine, as well as for identifying relatively subtle links between genotypes and phenotypes.

One set of limiting factors in current sequencing technologies derives from the “read length” of available sequencing reactions and the assembly processes used to assemble sequence reads. In general, it is possible to produce and manipulate nucleic acids (e.g., BAC or larger clones) that are much longer than the typical maximum length of nucleic acids that can be sequenced in a single reaction. For example, typical sequencing methods that rely on reaction product size separation, such as classical Sanger dideoxy sequencing, have a practical maximum read length of about 1,000 base pairs (bp) per reaction. See Chan, id. This actually represents a long read length for current sequencing technologies, i.e., many techniques in use have substantially sorter read lengths. To determine a sequence longer than the read length of the relevant reaction (the human genome, for example, comprises over 3 billion base pairs, with several individual chromosomes having over hundred million base pairs), overlapping sequences are typically assembled by aligning overlapping nucleic acids into contigs, which are ultimately assembled into the sequence of interest. For example, in the case of whole genome sequencing, contigs are ultimately assembled into essentially complete chromosomes (using available technologies, there are generally small gaps in “complete” genomic assemblies).

In current genomic sequencing efforts, millions of clones corresponding to the genome of interest are made and then randomly sequenced (a process referred to as “whole genome shotgun sequencing”). One drawback of this procedure is that most of the sequences produced in this process are duplicated, usually several times, because many regions are sequenced more than once, to ensure that at least one set of overlapping clones are sequenced during the random sequencing process for all (or at least most) regions of the genome of interest. The sequences of overlapping nucleic acids are then aligned, using various complex alignment algorithms, to provide contigs. See, e.g., Venter et al. (2001) “The sequence of the human genome,” Science 291: 1304-1351; She et al. (2004) “Shotgun sequence assembly and recent segmental duplications within the human genome” Nature 431: 927-930; Chimpanzee Sequencing and Analysis Consortium (2005) “Initial sequence of the chimpanzee genome and comparison with the human genome” Nature 437: 69-87; and Levy et al. (2007) “The Diploid Genome Sequence of an Individual Human” PLoS Biology Vol. 5, No. 10, e254 doi:10.1371/journal.pbio.0050254. Where available, previously sequenced genomes can also be used to provide logical scaffolds for sequence alignment, also using sophisticated alignment algorithms.

Whole genome shotgun sequencing was most recently used in sequencing J. Craig Venter's personal diploid genome, by performing 32 million sequence reads generated by a random shotgun sequencing approach, followed by algorithmic assembly using the open-source Celera Assembler. See, Levy et al. (2007) “The Diploid Genome Sequence of an Individual Human” PLoS Biology Vol. 5, No. 10, e254 doi: 10.1371/journal.pbio.0050254. The Celera Assembler, also known as the “Whole-Genome Shotgun (WGS) Assembler software suite” implements sophisticated algorithms for the reconstruction of genomic DNA sequence from data produced by WGS sequencing experiments. The Celera Assembler was originally developed at Celera Genomics and is now an open source project at SourceForge. As noted, this approach requires several fold oversequencing of the genome to be reasonably assured that (almost) all portions of the genome are actually sequenced and assembled into overlapping contigs. One further difficulty in the algorithmic assembly of sequence reads into a complete chromosome or genome is that repetitive sections of the genome are often inappropriately grouped into non-existent pseudo-contigs that are artifacts of the algorithm and of the presence of multiple identically overlapping nucleic acids.

For short read length technologies (e.g., technologies with average sequence reads shorter than about 100 bp), which typically provide massive parallelism to generate a large quantity of duplicative sequencing data, assembly of the sequences to provide a complete sequence of interest is a yet more complex process. This is because many more sequencing reads have to be performed to ensure complete coverage of a chromosome (or, ultimately, a genome) and because the short sequence reads provide more ambiguity during assembly with respect to, e.g., repetitive regions. The larger number of reads also inherently increases the number of overlaps that have to be aligned, with corresponding increases in alignment ambiguity caused by the resulting higher number of sequences with similar or identical overlaps that need to be assembled.

The present invention overcomes these difficulties, by providing a “virtual” read length that is longer than the actual read length of a sequencing reaction, reducing the amount of oversequencing required for assembly, and further by reducing ambiguities during sequence assembly. These and many other features will be apparent upon complete review of the following disclosure.

### SUMMARY OF THE INVENTION

The present invention uses positional information to provide an indication of sequence relationships between analyte nucleic acids. Long nucleic acid templates of interest are fragmented, and the resulting analyte nucleic acid fragments are analyzed (e.g., sequenced). Relative positional relationships between the analyte fragments is at least partly preserved (or logically transformed) such that positional relationships of the analyte fragments substantially correspond to subsequence relationships of the analyte fragments relative to the template nucleic acid. Thus, in one typical embodiment, a template nucleic acid comprising subsequences A, B, C . . . is fragmented into analyte nucleic acids A, B, C . . . comprising the corresponding A, B, C . . . subsequences of the template nucleic acid. The analytes can be bound or otherwise fixed in place in the positions in which they were generated, thereby positioning the analyte fragments such that the relative positions of the analyte fragments corresponds to subsequence relationships of the template nucleic acid. Position of the analyte fragments is at least partly retained or is logically transformed (e.g., in an array copying process) such that a spatial position of an analyte fragment at least partly correlates with the order of subsequences in the template nucleic acid. Thus, for example, analyte fragments A, B, C . . . are located such that the position of fragment A is proximal to the position of fragment B, which is proximal to the position of fragment C . . . where A, B, C . . . include subsequences of the template nucleic acid. This positional relationship is used to facilitate assembly of sequences of the analytes to provide the overall template nucleic acid sequence, in that the position of proximal analytes can be used as an indication that the sequences of the analytes are also proximal to one another in the template nucleic acid. This reduces the amount of oversequencing required to fully sample a genome and also reduces the unwanted production of false contigs during sequence assembly. The methods are particularly applicable to single molecule sequencing (SMS) approaches, e.g., SMS conducted in optically confined reaction structures such as zero mode waveguides (ZMWs).

Thus, in a first aspect, methods of determining at least one sequence of at least a portion of at least a first target nucleic acid are provided. The method includes distributing a plurality of target nucleic acids into a plurality of array processing regions, where they are cleaved to form an array of analyte nucleic acids. The analyte nucleic acids in each of the array processing regions comprise subsequences of the target nucleic acids. Further, positions of the analyte nucleic acids in the array processing regions are at least partially determined by relative positions of the subsequences in the target nucleic acids. For example, the analyte nucleic acids can be bound or otherwise localized in the array in the positions in which they were generated, resulting in a correspondence between the analyte positions and subsequence relationships in the template nucleic acid. A plurality of the analyte nucleic acids, or amplicons thereof, are sequenced, and sequences of the plurality of analyte nucleic acids are assembled. This assembly is based, at least in part, upon positions of the plurality of analyte nucleic acids in the array. The assembly provides a sequence of at least a portion of at least one of the target nucleic acids.

The methods are applicable to essentially any target nucleic acid of interest, and the method is especially well suited to analyzing genomic DNAs and clones thereof. The plurality of target nucleic acids can collectively comprise, e.g., a haplotype, chromosome, partial genome or complete genome for an organism. The target nucleic acids can be cleaved by any available method, e.g., cleavage with one or more restriction endonuclease enzyme, mechanical shearing, or the like. In alternative embodiments, the target nucleic acids are not cleaved; instead, fragments are generated by non-cleavage methods, such as primer extension or nick translation.

In one preferred class of embodiments, the analyte nucleic acids are sequenced by detecting incorporation of nucleotides during a polymerase-mediated primer extension reaction. These embodiments are especially useful for single-molecule sequencing (SMS) reactions, e.g., in which each of the analyte nucleic acids are separately sequenced. In one class of SMS applications, reactions are individually performed in separate optically confined regions of the array, e.g., in zero mode waveguides.

By assembling sequences of the SMS reactions, the analyte nucleic acids can be partially or completely sequenced. Sequences can be assembled based upon positions of the plurality of analyte nucleic acids by detecting or monitoring spatial positions of the analyte nucleic acids in the array, where relative spatial positions of the analyte nucleic acids in a processing region corresponds with an order of subsequences in a target nucleic acid. The relative spatial position is used to direct an order of sequence assembly for the plurality of analyte nucleic acids.

Typically, at least a portion of the analyte nucleic acids are arranged into a plurality of proximity regions in an array, with the relative positions of the analyte nucleic acids being at least partially determined by the relative positions of the analyte nucleic acid sequences in a target nucleic acid. Thus, the regions individually comprise a plurality of different analyte nucleic acids, with the different analyte nucleic acids in a first proximity region corresponding to a first sequence region of the first target nucleic acid and the analyte nucleic acids in a second proximity region corresponding to a second sequence region of the first target nucleic acid, or to a first region of a second target nucleic acid. In one class of embodiments, the proximity regions are determined in an approximation process. This process can include, e.g., defining an arbitrary set of region boundaries for the array, sequencing analyte nucleic acids from within the arbitrary region boundaries, assembling sequences of the analyte nucleic acids into contigs and, annotating the array to mark the contig relationships. This process suggests improved region boundaries for the analyte nucleic acids, thereby defining the proximity regions. Nucleic acids within the improved boundaries can be re-assembled into improved contigs after the approximation process.

In a related class of embodiments, related methods of determining at least one sequence of at least a portion of at least a first target nucleic acid are provided. The method includes distributing a plurality of target nucleic acids into a plurality of array processing regions, where the regions individually comprise one or more optically confined analysis region or regions. Fragments or partial fragments of the target nucleic acids are provided in the plurality of array processing regions to form an array of analyte nucleic acids. Cleavage or non-cleavage based (e.g., primer extension based) approaches for generating fragments can be used. Analyte nucleic acids in each of the array processing regions include subsequences of each of the target nucleic acids. Positions of the analyte nucleic acids in the array processing regions are at least partially determined by relative positions of the subsequences in the target nucleic acids. A plurality of the analyte nucleic acids, or amplicons thereof are sequenced and assembled, based, at least in part, upon positions of the plurality of analyte nucleic acids in the array. This provides a sequence of at least a portion of at least one of the target nucleic acids. All of the features noted above, e.g., with respect to templates, formats, and the like, are optionally applicable to this embodiment as well.

In these or the other embodiments noted herein, the array regions each optionally include a plurality of optically confined analysis regions (e.g., one or more ZMWs). The analyte nucleic acids are sequenced in the optically confined region(s). In this class of embodiments, the fragments or amplicons can be generated e.g., by cleaving the target nucleic acids, nick-translating the target nucleic acids, primer extension of a plurality of primers hybridized to the target nucleic acid, or by PCR amplification of the nucleic acid.

In a related class of embodiments, a method of making an array of analyte nucleic acids is provided. The method includes distributing a plurality of long nucleic acid molecules to separate array processing regions, where they are cleaved to produce a plurality of analyte nucleic acids in each of the processing regions. The analyte nucleic acids individually include a subsequence of a long nucleic acid molecule. The analyte nucleic acids are fixed in the regions in which they are generated, such that relative positions of the analyte nucleic acids in the processing regions correspond to relative positions of subsequences in the long nucleic acid molecules, thereby producing the array of analyte nucleic acids. Arrays made according to this method, or the other embodiments noted herein, are also a feature of the invention.

In these or the other embodiments herein, the long nucleic acid molecules (e.g., template nucleic acids to be sequenced) can be at least about 1,000 nucleotide residues in length, e.g., about 10,000, about 20,000, about 30,000, about 40,000 or about 50,000 or more nucleotide residues in length. The analyte nucleic acids in the respective processing or destination regions typically comprise members with overlapping subsequences of the long nucleic acids. Typically, the subsequences of the analyte nucleic acids to be sequenced will be of a length that is amenable to analysis by the sequencing method/system in use. For example, the subsequences of the analyte nucleic acids to be sequenced will typically be less than about 1200 nucleotides in length for Sanger sequencing applications, e.g., less than about 1,000 nucleotides, and often less than about 900 nucleotides in length. In sequencing by incorporation methods, in which sequencing is performed by detecting incorporation of labeled nucleotides, the read lengths can be shorter or longer, depending on the specific technology at issue. Thus, the relevant portions of the analyte nucleic acids can be longer or shorter. The analyte nucleic acids can also include cloning or purification tags (e.g., subsequences facilitating array attachment or sub cloning) or the like.

The long nucleic acid molecules can be bound to the different processing regions, typically prior to fragmentation. The long nucleic acids or other templates, or the analyte nucleic acids can be distributed to the processing or other array regions by available methods, such as pin spotting, photolithography, binding the respective nucleic acid to a particle, binding the respective nucleic acid to a nanoparticle, binding the respective nucleic acid to a bead, or the like. The respective array region can include the particle, nanoparticle, bead, or the like.

In the embodiments herein, the template nucleic acids or long nucleic acids can be in a stretched configuration prior to cleavage/fragmentation. Alternately, they can be in a random coil configuration. Fragmentation or cleavage of the long nucleic acid or other template can include cleaving the nucleic acid with one or more restriction endonuclease(s) in the array processing regions to produce the analyte nucleic acids.

Typically, the analyte nucleic acids can be bound or otherwise fixed to the respective regions in which they were generated. For example, the analyte nucleic acids can remain in one or more optically confined region of the processing region in which they were generated, e.g., by flowing into the confinement region, or being bound within the confinement region. The analyte nucleic acids are optionally amplified in the processing regions prior to being bound or fixed, although this is not generally necessary, particularly in SMS applications.

Arrays made by the methods herein, and arrays for use with the methods herein are also features of the invention. For example, the invention provides an array of nucleic acids that includes a plurality of nucleic acid analysis regions. Each region of the array includes a group of analyte nucleic acids produced by cleavage of a template nucleic acid, with sequences of the analyte nucleic acids corresponding to proximal subsequences of a template nucleic acid. The analyte nucleic acids are spatially arranged in the array such that the order of the analyte nucleic acids at least partially corresponds to the order of the subsequences in the template nucleic acid. As in the methods herein, the analysis regions can include, e.g., wells, microwells, nanowells, beads, nanobeads, pores, or optically confined structures such as ZMWs, or the regions can simply correspond to geographical addresses on a solid support. The features noted herein with respect to the methods can apply to the array embodiments as well, e.g., the arrays can include the various template and/or analyte nucleic acids, sequencing reagents, cleavage or fragmentation reagents, or the like.

Analysis systems for sequencing nucleic acids is also provided. The systems include an array reader and system instructions that convert signal information received from the array reader into nucleic acid sequence information. The instructions assemble the sequence information into a sequence of interest. Assembly of the sequence information into the sequence of interest includes correlating signal or sequence position information with a sequence region of the sequence of interest. For example, the system instructions can convert signal information into sequence information for a plurality of nucleic acid analytes that are spatially grouped into regions on an array that is read by the reader, by noting the region information for separately grouped analytes. Grouped analytes are assembled into sequence regions of the sequence of interest.

The analysis system can also include an array region approximation module. The module is designed to practice the approximation methods described above, e.g., by arbitrarily defining a set of arbitrary proximity region boundaries for the array. The module takes account of analyte nucleic acid sequences from within the arbitrary region boundary, assembles sequences of the analyte nucleic acids into contigs and annotates the array to mark the contig relationships. Based upon the contig information, the module suggests improved region boundaries, which can be used to refine or improve the assembly of the contigs, or the like.

Kits for practicing the methods, or for use with the arrays or systems herein are also a feature of the invention. Such kits can include arrays, reagents for cleaving nucleic acids on arrays, system components such as system software, or the like. The kits can also include packaging materials, instructions for using the array or system to practice the methods, control reagents (templates, analyte nucleic acids, sequencing reagents, etc.), or the like.

### BRIEF DESCRIPTION OF THE FIGURE

FIG. 1 is a schematic illustration of an example method of the invention.

FIG. 2 is a schematic illustration of a system of the invention.

### DETAILED DESCRIPTION

Nucleic acids are analyzed in array formats in a variety of contexts, including, e.g., in nucleic acid sequencing applications. In the present invention, nucleic acid template (typically DNA) molecules are distributed into processing regions of an array, where they are fragmented (e.g., by cleavage). Relative positions of the resulting fragments is at least partly maintained, e.g., by binding, fixing or otherwise retaining the fragments in place where they are generated, such that the geographical (spatial) position of the fragments on the array is an indicator for the relative position of subsequences of the fragments in the long nucleic acid templates. Relative positional relationships between the analyte fragments is at least partly preserved (or logically transformed, e.g., by an array transfer process that transfers the analytes to a selected destination region, e.g., in an array copying process) such that positional relationships of the analyte fragments substantially correspond to subsequence relationships of the analyte fragments relative to the template nucleic acid. Assembly of analyte nucleic acid sequences takes account of this positional correlation, facilitating assembly of the analyte sequences into contigs.

In general, a proximity relationship among analyte nucleic acids “corresponds” to subsequence relationships when the relative positional relationships of the analyte nucleic acids are substantially or completely preserved as compared to the subsequences of the template nucleic acid from which they were derived. Thus, in one typical embodiment, a template nucleic acid comprising subsequences A, B, C . . . is fragmented into analyte nucleic acids A, B, C . . . comprising the corresponding A, B, C . . . subsequences of the template nucleic acid. Position of the analyte fragments is at least partly or substantially retained or is logically transformed such that a spatial position of an analyte fragment at least partly correlates with the order of subsequences in the template nucleic acid. Thus, for example, analyte fragments A, B, C . . . are located such that the position of fragment A is proximal to the position of fragment B, which is proximal to the position of fragment C . . . where A, B, C . . . include subsequences of the template nucleic acid. This positional relationship is used to facilitate assembly of sequences of the analytes to provide the overall template nucleic acid sequence, in that the position of proximal analytes can be used as an indication that the sequences of the analytes are also at least approximately proximal to one another in the template nucleic acid. This reduces the amount of over sequencing required to fully sample a genome and also reduces the unwanted production of false contigs during sequence assembly. The methods are particularly applicable to single molecule sequencing (SMS) approaches, e.g., SMS conducted in optically confined reaction structures such as zero mode waveguides (ZMWs).

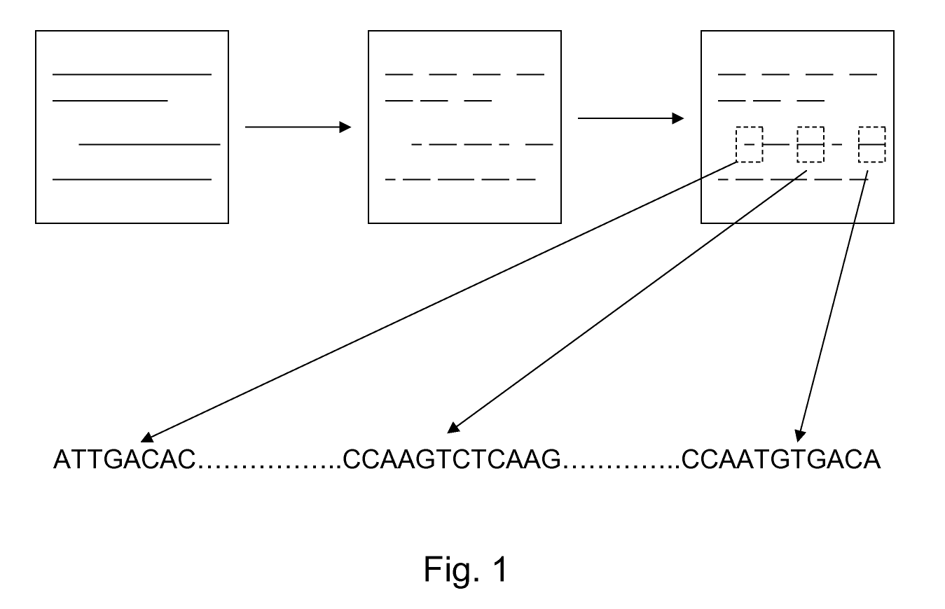

This approach is further schematically illustrated in FIG. 1. As shown, template nucleic acids are fixed to a surface and fragmented in place. The resulting fragments are sequenced in place, with the resulting subsequences having a relationship in the template nucleic acid that corresponds to proximity relationships for the fragments.

### Providing Nucleic Acid Templates

Template nucleic acids that are the target of a sequencing reaction can be provided from any of a variety of available sources. The nucleic acids can be genomic nucleic acids, cloned nucleic acids, in vitro amplified nucleic acids, or the like. The nucleic acids are typically longer than the read length of the sequencing technology used to sequence analyte nucleic acids that are produced by fragmentation of the template nucleic acids. Thus, the term “long nucleic acids” is a relative term that indicates the nucleic acids are longer than the read length of the relevant sequencing reaction. This can be as short as a few hundred nucleotide residues (nt), e.g., where the read lengths of the technology are shorter than a typical Sanger reaction, but more typically the long templates will be over 1,000 nt in length (the approximate practical read length for typical Sanger reaction), e.g., often more than about 5,000 nt, and often about 10,000 nt, about 20,000 nt, about 30,000 nt, about 40,000 nt, about 50,000 nt, or longer. Whether cloned or genomic, the template nucleic acid(s) to be sequenced can (separately or collectively) include a chromosome region, haplotype, chromosome, partial genome or complete genome for an organism. The nucleic acid can be single stranded, partially double stranded, or double stranded, depending on the format of the sequencing reaction to be used. The configuration of the nucleic acids for analysis (stretched, random coil, etc.) can be selected by the user by selecting environmental conditions (salt, pH, temperature, presence of associated proteins, etc.) for the nucleic acid. Further details for selecting and determining nucleic acid configuration are found in the references noted below.

A relevant determinant of template nucleic acid length is the source of the template. Typical cloning template sources for plasmid DNAs can be as large as about 10 kb. Cosmids and fosmids can contain an insert of interest that is up to about 30 kb in length (Ung-Jin Kim et al. (1992) “Stable propagation of cosmid-sized human DNA inserts in an F-factor based vector” Nucleic Acids Res. 20:1083-1085). Typical bacterial artificial chromosome (BAC) templates are on the order of about 150 kb, and a BAC can handle inserts of up to about 350 kb (Shizuya et al. (1992) “Cloning and stable maintenance of 300-kilobase-pair fragments of human DNA in Escherichia coli using an F-factor-based vector” Proc. Natl. Acad. Sci. 89; 8794-8797 PNAS). Yeast artificial chromosome (YAC) vectors can contain larger DNA clones, e.g., of between about 100 kb and 3000 kb (Burke et al. (1987) “Cloning of large segments of DNA into yeast by means of artificial chromosome vectors,” Science 226:806-812; Larionov et al. (1996) “Specific cloning of human DNA as YACs by transformation-associated recombination,” Proc Nat Acad Sci USA 93:491-496. Human artificial chromosome (HAC) vectors can handle on the order of 6-10 million nt (Harrington et al. (1997) “Formation of de novo centromeres and construction of first-generation human artificial microchromosomes” Nature Genetics 15: 345-355).

Many other cloning systems are known and can be used as a source of template nucleic acids. Further details regarding nucleic acid conformation, plasmids, cosmids, YACs, and some other vectors noted above can be found in Berger and Kimmel, Guide to Molecular Cloning Techniques, Methods in Enzymology volume 152 Academic Press, Inc., San Diego, Calif. (Berger); Sambrook et al., Molecular Cloning—A Laboratory Manual (3rd Ed.), Vol. 1-3, Cold Spring Harbor Laboratory, Cold Spring Harbor, N.Y., 2000 (“Sambrook”); Current Protocols in Molecular Biology, F. M. Ausubel et al., eds., Current Protocols, a joint venture between Greene Publishing Associates, Inc. and John Wiley & Sons, Inc; Kaufman et al. (2003) Handbook of Molecular and Cellular Methods in Biology and Medicine Second Edition Ceske (ed) CRC Press (Kaufman); and The Nucleic Acid Protocols Handbook Ralph Rapley (ed) (2000) Cold Spring Harbor, Humana Press Inc (Rapley).

In addition to cloned nucleic acids, template nucleic acids can be provided from genomic nucleic acids, e.g., genomic DNAs. This approach is most useful when high copy numbers of a template are not necessary for the relevant sequencing technologies, e.g., in single molecule sequencing (SMS) applications. Genomic DNA (or RNA, where applicable) can be provided from cell cultures, from tissues, or from intact organisms. Further details on cell and tissue culture can be found in Sambrook and Ausubel (above), as well in Freshney (1994) Culture of Animal Cells, a Manual of Basic Technique, third edition, Wiley-Liss, New York and the references cited therein; Payne et al. (1992) Plant Cell and Tissue Culture in Liquid Systems, John Wiley & Sons, Inc. New York, N.Y.; and, Gamborg and Phillips (eds) (1995) Plant Cell, Tissue and Organ Culture; Fundamental Methods Springer Lab Manual, Springer-Verlag (Berlin Heidelberg N.Y.). Cell culture media in general are also set forth in Atlas and Parks (eds) The Handbook of Microbiological Media (1993) CRC Press, Boca Raton, Fla. Additional information for cell culture is found in available commercial literature such as the Life Science Research Cell Culture Catalogue (1998) from Sigma-Aldrich, Inc (St Louis, Mo.) (“Sigma-LSRCCC”) and, e.g., the Plant Culture Catalogue and supplement (e.g., 1997 or later) also from Sigma-Aldrich, Inc (St Louis, Mo.) (“Sigma-PCCS”). Samples can also be taken directly from an organism of interest, e.g., a human following informed consent, or other animal following appropriate standards of humane care for the animal. Plants can provide sources of template nucleic acid, e.g., following appropriate cultivation or harvesting methods.

In addition, essentially any nucleic acid can be made synthetically, or ordered from a commercial supplier such as Operon (Huntsville, Ala.), IDT (Coralville, Iowa) or Bioneer (Alameda, Calif.). Such synthetic template can be useful as positive controls, e.g., because the sequence of such nucleic acids is typically known following synthesis.

Distributing Long Nucleic Acids into Arrays

Template nucleic acids can be distributed into array processing regions using available methods. These include pin spotting or photolithography onto a planar substrate, and/or binding of the respective nucleic acid to a particle such as a bead, nanoparticle, or the like, where the particles are distributed into arrays. Many different array formats are in current use and template nucleic acids can be fixed to arrays as appropriate to the relevant format. For an introduction to nucleic acid arrays, including the distribution and fixation of nucleic acids, see, e.g., Kimmel and Oliver (Eds) (2006) DNA Microarrays Part A: Array Platforms & Wet-Bench Protocols, Volume 410 (Methods in Enzymology) ISBN-10: 0121828158; Kimmel and Oliver (Eds) (2006) DNA Microarrays, Part B: Databases and Statistics Volume 411 (Methods in Enzymology) ISBN-10: 0121828166; Alan R. Kohane et al. (2005) Microarrays for an Integrative Genomics MIT Press ISBN: 0262612100; Hardiman (2003) Microarrays Methods and Applications (Nuts & Bolts series) DNA Press, USA; Baldi and Hatfield (2002) DNA Microarrays and Gene Expression Cambridge University Press; ISBN: 0521800226; Bowtell and Sambrook (Eds) (2002) DNA Microarrays: A Molecular Cloning Manual David Paperback: 1st edition Cold Spring Harbor Laboratory; ISBN: 0879696257; Microarrays and Related Technologies Miniaturization and Acceleration of Genomics Research (May 1, 2001) Cambridge Healthtech Institute ISBN: B00005TXRM; Rampal (ed) (2001) DNA Arrays: Methods and Protocols (Methods in Molecular Biology, Vol 170 Humana Press, ISBN: 089603822X; Schena (2000) Microarray Biochip Technology Eaton Pub Co ISBN: 1881299376; and Schena (Editor) (1999) DNA Microarrays: A Practical Approach (Practical Approach Series) Oxford Univ Press, ISBN: 0199637768.

Spotting of nucleic acids onto substrates for sequencing or other analysis can be performed using various pin spotting methods, including automated approaches that use robotics to increase the reliability and throughput of this process. For a review of spotting methods, see, Auburn et al. (2005) “Robotic spotting of cDNA and oligonucleotide microarrays” Trends in Biotechnology 23(7):374-379 (Auburn), as well as the references above, e.g., Kimmel and Oliver (Eds) (2006) DNA Microarrays Part A: Array Platforms & Wet-Bench Protocols, Volume 410 (Methods in Enzymology) ISBN-10: 0121828158 (Kimmel 2006 A). In these approaches, a “spotting capillary,” “pin” or “printing pin” structure is loaded with a template of interest, and the contacted to microarray substrate, depositing a reagent to form a microarray feature on that substrate. See Kimmel 2006 A, Auburn, and Matson (2004) Applying Genomic and Proteomic Microarray Technology in Drug Discovery CRC Press, Boca Raton, Fla. (Matson). Common methods of spotting template nucleic acids onto a surface use solid or split metal pins, or in some applications, capillaries, to transfer template nucleic acids onto a substrate. The pins are dipped into wells containing the template of interest, where they pick up a small amount of the DNA. The pins are contacted to the substrate, where they deposit the template. Suppliers such as GE Healthcare and Hitachi Genetic Systems/MiraiBio produce spotting robots for use with both types of pin. See Auburn and Matson above; See also Gwynne and Heebner (2005) “Biochips—Array of Applications” Science (Special Advertising Section, March 04 edition); Holloway (2002) “Options available—from start to finish—for obtaining data from DNA microarrays II,” Nat. Genet. 32 (2):481-9.

Another spotting technique for delivering nucleic acids to a surface is based on inkjet technology. There are two basic types of inkjet delivery. The first uses a solenoid valve, while the second uses a piezo-electric device. Solenoid technology delivers larger spots, while piezo electric printing can deliver nucleic acids to very fine array features. A review of ink jet printing methods for making nucleic acid arrays is found in the references relating to array methods noted above, e.g., Kimmel 2006 A. See also, Lee (2002) Microdrop Generation (Nano-and Microscience, Engineering, Technology and Medicine) CRC Press ISBN-10: 084931559X; and Heller (2002) “DNA MICROARRAY TECHNOLOGY: Devices, Systems, and Applications” Annual Review of Biomedical Engineering 4: 129-153.

Photolithography provides another useful method for distributing template nucleic acids onto a surface. In this approach, capture oligonucleotides are synthesized on a substrate using standard cycles of photoprotection and deprotection. These capture oligonucleotides are hybridized to the template nucleic acids of interest, thereby localizing them to specific regions of the array. The templates can be fixed in these regions by coupling with the oligonucleotides or to the substrate (e.g., by ligation, by preserving hybridization to the oligonucleotide, or by chemical coupling), or by mechanical segregation of the substrate. For example, if the substrate is a particle, the particles can be distributed into flow cells, channels, depressions, wells, optical confinement regions, or other physical features. See, the references noted above, e.g., Kimmel and Oliver (Eds) (2006) DNA Microarrays Part A: Array Platforms & Wet-Bench Protocols, Volume 410 (Methods in Enzymology) ISBN-10: 0121828158. Further details regarding available bead-based array formats are also found in Kimmel and Oliver, id., as well as in the references noted above.

In one useful application, the arrays comprise arrays of zero mode waveguides. Nucleic acid templates can be attached to the arrays using the methods noted above. The waveguides provide physically discrete optical confinement regions that can be used to retain analyte nucleic acids after fragmentation of the templates. For a description of zero mode waveguide arrays, see, e.g., Levene et al. (2003) “Zero Mode Waveguides for single Molecule Analysis at High Concentrations,” Science 299:682-686; U.S. Patent Application No. 2003/0044781, and U.S. Pat. No. 6,917,726, each of which is incorporated herein by reference in its entirety for all purposes. In one example of these applications, the template nucleic acid is distributed across several optical confinement regions. Following fragmentation, the resulting analyte nucleic acids drop into the confinement regions, where they are sequenced, e.g., in a single-molecule sequencing reaction. For example, a polymerase can be bound in the waveguide in which the sequencing reaction is performed; the addition of appropriately labeled nucleotides is used to determine sequences of the analyte nucleic acids. For a description of polymerases that can incorporate appropriate labeled nucleotides see, e.g., Hanzel et al. POLYMERASES FOR NUCLEOTIDE ANALOGUE INCORPORATION, WO 2007/076057. For a description of polymerases that are active when bound to surfaces, which is useful in single molecule sequencing reactions in which the enzyme is fixed to a surface, e.g., conducted in a zero mode waveguide, see Hanzel et al. ACTIVE SURFACE COUPLED POLYMERASES, WO 2007/075987 and Hanzel et al. PROTEIN ENGINEERING STRATEGIES TO OPTIMIZE ACTIVITY OF SURFACE ATTACHED PROTEINS, WO 2007/075873). For further descriptions of single molecule sequencing applications utilizing ZMWs, see Levene et al. (2003) “Zero Mode Waveguides for single Molecule Analysis at High Concentrations,” Science 299:682-686; U.S. Pat. No. 7,033,764, U.S. Pat. No. 7,052,847, U.S. Pat. No. 7,056,661, and U.S. Pat. No. 7,056,676, the full disclosures of which are incorporated herein by reference in their entirety for all purposes.

### Fragmenting Template Nucleic Acids to Produce Analyte Nucleic Acids

Template nucleic acids can be fragmented in either of at least two different ways. First, the nucleic acids can be cleaved, e.g., with a restriction endonuclease. Second, the nucleic acid template can be nick translated, or can be partly copied in primer extension reaction (e.g., as in PCR). Combinations of these methods can also be used. Regardless of the fragmentation method, positional correlation between the position of the fragments and subsequences of the template nucleic acid is maintained. This can be done by fixing fragments of the template nucleic acid in a positional relationship, in the array regions in which they are generated, that corresponds to subsequence relationships of the template nucleic acid. For example, as shown in FIG. 1, template nucleic acids are fixed to a surface and fragmented in place. The resulting fragments are fixed in place (e.g., bound, or otherwise confined on the surface) and sequenced, with the resulting subsequences having a relationship in the template nucleic acid that corresponds to proximity relationships for the fragments. Accordingly, in a first aspect, template nucleic acids are fragmented by cleavage. Approaches for cleaving nucleic acid fragments most commonly include enzymatic digestion, e.g., with a restriction endonuclease or cocktail of endonucleases. Other approaches include sonication, mechanical shearing, electrochemical cleavage, nebulization, or the like. It is expected that one of skill can perform these known fragmentation methods. Further details regarding these methods can be found in Sambrook, Ausubel, Kaufman, Berger, and Rapley supra. Further details regarding electrochemical cleavage reactions can also be found in Grimshaw (2000) Electrochemical Reactions and Mechanisms in Organic Chemistry Elsever Science (Amsterdam, the Netherlands).

In a second approach, nucleic acids are fragmented using a primer extension reaction. Primers are bound to a single-stranded portion of the template, and extended with a polymerase reaction to produce fragments of the template. Optionally, the primers can be generated by nicking a double stranded template, e.g., using DNase I. Alternately, the primers can be chemically synthesized and then annealed to the template nucleic acid. Optionally, the template is partially or completely amplified to produce fragments, e.g., using a polymerase-based reaction such as PCR, or using rolling circle amplification. Details regarding available polymerases can be found, e.g., in Burgers et al. (2001) “Eukaryotic DNA polymerases: proposal for a revised nomenclature” J Biol. Chem. 276(47):43487-90; Hübscher et al. (2002) EUKARYOTIC DNA POLYMERASES Annual Review of Biochemistry Vol. 71: 133-163; Alba (2001) “Protein Family Review: Replicative DNA Polymerases” Genome Biology 2(1):reviews 3002.1-3002.4; and Steitz (1999) “DNA polymerases: structural diversity and common mechanisms” J Biol Chem 274:17395-17398. Details regarding PCR can be found in Sambrook, Ausubel, Kaufman, Berger, and Rapley, supra, as well as in PCR Protocols A Guide to Methods and Applications (Innis et al. eds) Academic Press Inc. San Diego, Calif. (1990) (Innis); Chen et al. (ed) PCR Cloning Protocols, Second Edition (Methods in Molecular Biology, volume 192) Humana Press; and in Viljoen et al. (2005) Molecular Diagnostic PCR Handbook Springer, ISBN 1402034032. Further details regarding Rolling Circle Amplification can be found in Demidov (2002) “Rolling-circle amplification in DNA diagnostics: the power of simplicity,” Expert Rev. Mol. Diagn. 2(6): 89-94; Demidov and Broude (eds) (2005) DNA Amplification: Current Technologies and Applications. Horizon Bioscience, Wymondham, UK; and Bakht et al. (2005) “Ligation-mediated rolling-circle amplification-based approaches to single nucleotide polymorphism detection” Expert Review of Molecular Diagnostics, 5(1) 111-116.

### Further Information Regarding Strategies for Maintaining Positional Relationships

As shown in FIG. 1, template nucleic acids are confined on a surface (e.g., by chemical linkage, confinement in various physical features, etc.) and fragmented in place. The resulting fragments are fixed in place (e.g., bound, or otherwise confined on the surface) and sequenced, with the resulting subsequences having a relationship in the template nucleic acid that corresponds to proximity relationships for the fragments.

In general, DNA molecules that are longer than the read length available from the relevant sequencing technology can be immobilized onto any surface relevant to the sequencing technology at hand (planar substrates, flow cells, beads, etc.). These long molecules are fragmented, and the fragments can be attached or confined, amplified in place, or otherwise prepared for sequencing according to the relevant sequencing method to be used. The resulting distribution of analyte molecules on the relevant surface(s) displays similarities to distributions already available for sequencing technologies, with the difference being that the geographic/spatial position of the analyte molecules or clonal populations thereof correlates with the genomic position of the sequence read with some level of accuracy or correlation. The molecules to be fragmented can be elongated (See, e.g., Schwartz et al. Method for Analyzing Nucleic Acid Reactions U.S. Pat. No. 6,607,888), or they can be affixed in a random coil configuration. In either case, information about the geographic location of the read can be used to assist in assembly of the genome, in contrast to previous methods, in which this information is used to identify a read and to assemble information from one base to the next, without taking context into account.

Many methods can be used to achieve or maintain positional correlation between the analyte nucleic acids and a genomic read position. As noted, both random coil and elongated nucleic acids can be used for the assembly process. In addition, depending on the format of the sequencing reaction, arrays of small, e.g., nanometer to micron sized reactions on an array can be used to amplify nucleic acids prior to affixing them to the array surface. This process can include amplifying either the template nucleic acid, or the analyte nucleic acid fragments, or both.

In these applications, geographic/spatial correlation can also or additionally be preserved by mating two surfaces, where one comprises the analyte or template nucleic acids e.g., in a standard blotting procedure, or by using other available array copy or transfer methods. Transfer procedures can change spatial relationships (e.g., when changing from a first array format into a second different format), provided this is done in a logical way that permits subsequent correspondence of the changed spatial relationships to original spatial relationships.

Rolling circle amplification can also be used to make large assemblages of geographically/spatially correlated nucleic acids, e.g., bound together with a strand displacing polymerase. These assemblages of nucleic acid can be affixed to a surface at random, with the reads in the vicinity of the assemblage being evaluated for membership in a given portion of the assemblage. Emulsion processes can be used for this purpose, in which single loops of DNA can be amplified via PCR or rolling circle amplification. Restriction endonuclease digestion and/or ligation can take place in this format as well, to assist with the preparation of analyte fragments for sequencing.

Specific hybridization can be used to geographically organize sequence reads for the enhanced contig assembly process of the invention. Microarray methods can be used to attach molecules to the surface, which can optionally be covalently linked by ligation, or simply left bound by the hybridization interaction. The relevant sequencing technology can be conducted on the substrate as noted, with the particular locations on the substrate generating reads that are predominantly from specifically hybridized molecules, facilitating improved assembly of the contigs. This approach can be conducted with pin-spotted arrays, lithographically generated arrays (either using masking methods or directed light patterning approaches), and/or with nanoparticle or bead-immobilized arrays. For additional formats for nucleic acid analysis see Schwartz et al. Method for Analyzing Nucleic Acid Reactions U.S. Pat. No. 6,607,888, which is incorporated herein by reference for all purposes.

### Sequencing the Analyte Nucleic Acids

A wide variety of sequencing methods are available for array-based sequencing, and can be adapted to the present invention by applying the methods to arrays of analyte nucleic acids (i.e., those herein that display a correlation of spatial relationships with subsequence information in template nucleic acids, produced as noted). In general, sequencing methods in which large contigs are assembled from shorter analyte nucleic acids can benefit from the contig assembly methods herein.

Examples of sequencing methods that can be formatted into arrays include massively parallel pyrosequencing (Leamon et al. (2003) “A massively parallel PicoTiterPlate based platform for discrete picoliter-scale polymerase chain reactions,” Electrophoresis 24: 682-686), chip-based DNA sequencing by synthesis (DSS) (Seo et al. (2004) “Photocleavable fluorescent nucleotides for DNA on a Chip Constructed by Site-Specific Coupling Chemistry,” Proc. Natl. Acad. Sci. U.S.A. 101:5488-5493); Sequencing using polymerase colonies (Mitra et al. (2003) “Fluorescent in situ Sequencing on Polymerase Colonies,” Anal. Biochem. 320: 55-65); zero mode waveguides (ZMWs) for real-time single molecule sequencing (Levene et al. (2003) “Zero Mode Waveguides for single Molecule Analysis at High Concentrations,” Science 299:682-686), flow-cell based array sequencing using reversible terminators (Fields (2007) “Site-seeing by sequencing” Science 316(5830): 1441-1442 and Bentley (2006) “Whole-genome re-sequencing” Curr Opin Genet Dev 16(6): 545-552) as well as sequencing by hybridization and classical Sanger methods arranged into array-based sequencing formats (see, e.g., Sambrook, Ausubel, Kimmel 2006 A, Kimmel 2006 B). In general, any sequencing method that can be performed in a way that maintains (or logically transforms) the relative position of the analyte nucleic acids can be used.

Assembling Analyte Nucleic Acid Sequences into Contigs, Taking Positional Correlation into Account

In the present invention, the position of analyte nucleic acids within geographic areas can be used to direct contig assembly. This can include applying geographic relational information as a logical filter during assembly, e.g., by assembling analyte sequences within geographic regions of an array, and/or by disallowing putative contigs that do not reflect a geographical relationship. In the first instance, knowledge that analytes from within a geographic area display a correspondence to subsequences in a template greatly simplifies the contig assembly process, requiring less oversequencing to achieve target nucleic acid (or genome) coverage. In the second instance, disallowing non-related analyte nucleic acids from improper contig assembly reduces contig assembly errors resulting from repetitive sequences. This process can also be reiterative, e.g., related regions can be determined in an approximation process. This can be performed, e.g., by first defining an arbitrary set of region boundaries for the array, followed by sequencing analyte nucleic acids from within the arbitrary region boundaries. Sequences of the analyte nucleic acids are assembled into contigs, with the array being annotated (typically in silico) to mark the contig relationships, thereby suggesting improved region boundaries. This process can be repeated one or more times to improve the understanding of the region boundaries, thereby improving ultimate sequence assembly.

Available assemblers can be used to assemble contigs from geographic regions of an array. That is, the reads from a particular geographic region can be assembled using available contig assembly packages, or the geographic read information can be used as a logical assembly filter during such assembly. For example, the publicly available open-source “Whole-Genome Shotgun (WGS) Assembler software suite” implements sophisticated algorithms for the construction of contigs. This assembler is an open source project at SourceForge; other commercial or shareware packages that facilitate contig assembly are also available, including SeqAssem from SequentiX-Digital DNA Processing (Germany), Arachne 2.0.1 from the Broad Institute (Cambridge, Mass.), DNA BASER—affordable contig assembly 2.3.2.001 and DNA BASER 2.7.8 both from CubicDesign, as well as many others.

Alternately, contig assembly software can be designed to consider geographical relationships from the outset. Such software can include features that facilitate definition of the geographic regions, further simplifying contig assembly. For example, in one implementation, a geographic area is arbitrarily defined and all of the reads derived from within the arbitrary boundaries are assembled into contigs. This process is repeated for, e.g., the entire surface area, using arbitrary boundaries. The surface is then annotated according to contig membership, and these annotations serve to highlight the actual boundaries between geographic regions. The process is repeated using the new improved boundaries and the contigs are assembled using conventional methods.

Systems for performing this analysis are also a feature of the invention. For example, systems can include an array reader and system instructions (embodied, e.g., in a computer or information appliance) that convert signal information received from the array reader into nucleic acid sequence information. The instructions can be set to assemble the sequence information into an overall sequence of interest, e.g., using the methods described herein. Assembly of the sequence information into the sequence of interest by the system typically includes correlating signal or sequence position information with a sequence region of the sequence of interest. For example, the system instructions can convert signal information into sequence information for a plurality of nucleic acid analytes that are spatially grouped into regions on an array that is read by the reader, with the instructions noting the region information for separately grouped analytes. The system software can then assemble grouped analytes into sequence regions of the sequence of interest. This facilitates overall assembly of an overall sequence of interest (e.g., chromosome, genome, etc.), because the context of various subsequences is determined by the geographical location in which the subsequence is read by the system. Optionally, the system can also include an array region approximation module. For example, the approximation module can arbitrarily define a set of arbitrary proximity region boundaries for the array; taking account of analyte nucleic acid sequences from within the arbitrary region boundaries. The module then assembles sequences of the analyte nucleic acids into contigs, annotating the array to mark the contig relationships. Based upon the contig information, the module suggests or determines improved region boundaries, further refining the relationship between geographical location of a subsequence and the overall context of the sequence in an overall analyte nucleic acid of interest.

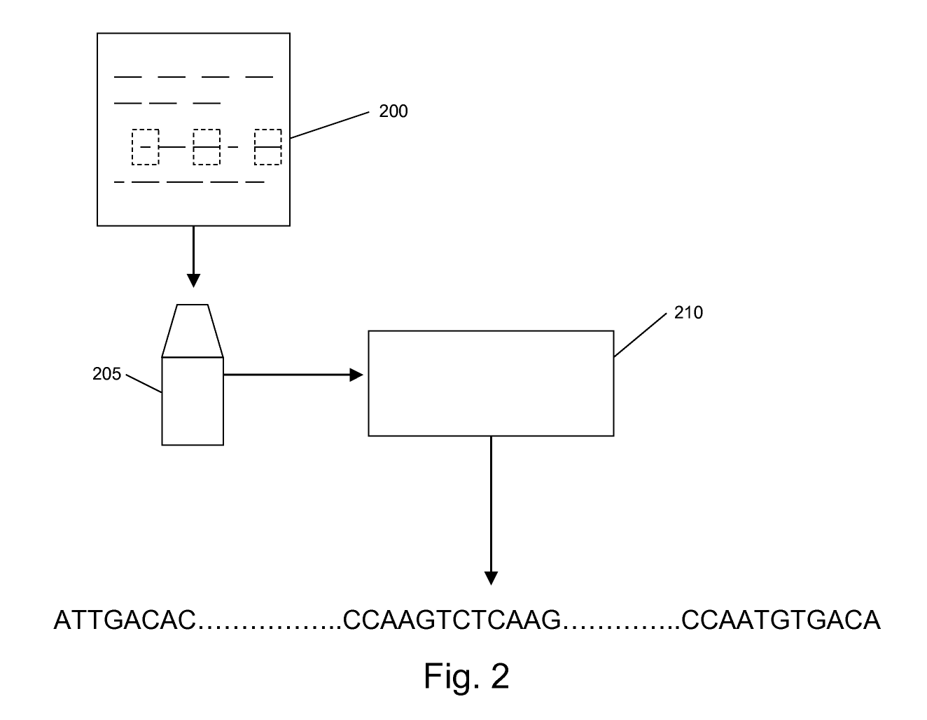

A schematic of such a system is depicted in FIG. 2. As shown, array 200 is read by array reader 205, which is operably coupled to sequence assembly module 210 (e.g., a computer) that comprises system instructions for sequence assembly, including, e.g., the approximation module noted above. As shown, the system optionally comprises a user viewable output (e.g., CRT, paper print out or the like) that displays assembled sequences to a user.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually and separately indicated to be incorporated by reference for all purposes.

What is claimed is:

1. A method of determining at least one sequence of at least a portion of at least a first target nucleic acid, the method comprising:
distributing a plurality of target nucleic acids into a plurality of array processing regions;
cleaving the target nucleic acids in the plurality of array processing regions to form an array of analyte nucleic acids, wherein analyte nucleic acids in each of the array processing regions comprise subsequences of each of the target nucleic acids, and wherein positions of the analyte nucleic acids in the array processing regions are at least partially determined by relative positions of the subsequences in the target nucleic acids;
sequencing a plurality of the analyte nucleic acids, or amplicons thereof; and,
assembling sequences of the plurality of analyte nucleic acids based, at least in part, upon positions of the plurality of analyte nucleic acids in the array, thereby providing a sequence of at least a portion of at least one of the target nucleic acids.

2. The method of claim 1, wherein the target nucleic acids are genomic DNAs, or clones thereof.

3. The method of claim 1, wherein the plurality of target nucleic acids collectively comprise a haplotype, chromosome, partial genome or complete genome for an organism.

4. The method of claim 1, wherein the target nucleic acids are cleaved with one or more restriction endonuclease enzyme.

5. The method of claim 1, wherein the analyte nucleic acids are sequenced by detecting incorporation of nucleotides during a polymerase-mediated primer extension reaction.

6. The method of claim 5, wherein each of the analyte nucleic acids are completely sequenced.

7. The method of claim 5, wherein each of the analyte nucleic acids are separately sequenced in single-molecule sequencing reactions.

8. The method of claim 5, wherein each of the analyte nucleic acids are individually sequenced in separate optically confined regions of the array.

9. The method of claim 8, wherein the optically confined region comprises a zero mode waveguide.

10. The method of claim 1, wherein assembling sequences based upon positions of the plurality of analyte nucleic acids comprises detecting or monitoring spatial positions of the analyte nucleic acids in the array, wherein relative spatial positions of the analyte nucleic acids in a processing region corresponds with an order of subsequences in a target nucleic acid, and wherein the relative spatial position is used to direct an order of sequence assembly for the plurality of analyte nucleic acids.

11. The method of claim 10, wherein at least a portion of the analyte nucleic acids are arranged into a plurality of proximity regions in an array, wherein regions individually comprise a plurality of different analyte nucleic acids, wherein the different analyte nucleic acids in a first proximity region correspond to a first sequence region of the first target nucleic acid and wherein the analyte nucleic acids in a second proximity region correspond to a second sequence region of the first target nucleic acid, or to a first region of a second target nucleic acid.

12. The method of claim 11, wherein the proximity regions are determined in an approximation process, comprising:
defining an arbitrary set of region boundaries for the array;
sequencing analyte nucleic acids from within the arbitrary region boundaries;
assembling sequences of the analyte nucleic acids into contigs; and,
annotating the array to mark the contig relationships, thereby suggesting improved region boundaries for the analyte nucleic acids, which improved region boundaries define the proximity regions.

13. The method of claim 12, wherein the nucleic acids within the improved boundaries are re-assembled into improved contigs.

14. A method of determining at least one sequence of at least a portion of at least a first target nucleic acid, the method comprising:
distributing a plurality of target nucleic acids into a plurality of array processing regions, wherein the regions individually comprise one or more optically confined analysis region or regions;
generating fragments or partial amplicons of the target nucleic acids in the plurality of array processing regions to form an array of analyte nucleic acids, wherein analyte nucleic acids in each of the array processing regions comprise subsequences of each of the target nucleic acids, and wherein positions of the analyte nucleic acids in the array processing regions are at least partially determined by relative positions of the subsequences in the target nucleic acids;
sequencing a plurality of the analyte nucleic acids, or amplicons thereof; and,
assembling sequences of the plurality of analyte nucleic acids based, at least in part, upon positions of the plurality of analyte nucleic acids in the array, thereby providing a sequence of at least a portion of at least one of the target nucleic acids.

15. The method of claim 14, wherein the array regions each comprise a plurality of optically confined analysis regions, wherein the analyte nucleic acids are sequenced in the optically confined regions.

16. The method of claim 14, wherein the optically confined analysis regions comprise one or more zero mode waveguide or waveguides.

17. The method of claim 14, wherein the fragments or amplicons are generated by one or more of: cleaving the target nucleic acids, nick-translating the target nucleic acids, primer extension of a plurality of primers hybridized to the target nucleic acid, or PCR amplification of the nucleic acid.

18. A method of making an array of analyte nucleic acids, the method comprising:
(a) distributing a plurality of long nucleic acid molecules to separate array processing regions;
(b) cleaving the long nucleic acid molecules in the array processing regions to produce a plurality of analyte nucleic acids in each of the processing regions, each analyte nucleic acid comprising a subsequence of a long nucleic acid molecule; and,
(c) fixing the analyte nucleic acids in the regions in which they are generated, such that relative positions of the analyte nucleic acids in the processing regions corresponds to relative positions of subsequences in the long nucleic acid molecules, thereby producing the array of analyte nucleic acids.

19. The method of claim 18, wherein the long nucleic acid molecules are at least 10,000 nucleotide residues in length.

20. The method of claim 18, wherein the long nucleic acid molecules are at least 50,000 nucleotide residues in length.

21. The method of claim 18, wherein (a) comprises binding a plurality of different long nucleic acid molecules to different processing regions.

22. The method of claim 18, wherein the long nucleic acids or the analyte nucleic acids are distributed to the processing regions by one or more of: pin spotting, photolithography, binding the respective nucleic acid to a particle, binding the respective nucleic acid to a nanoparticle, or binding the respective nucleic acid to a bead.

23. The method of claim 22, wherein the respective array region comprises the particle, nanoparticle or bead.

24. The method of claim 18, wherein the long nucleic acids are in a stretched configuration prior to (b).

25. The method of claim 18, wherein the long nucleic acids are in a random coil configuration prior to (b).

26. The method of claim 18, wherein (b) comprises cleaving the long DNA molecules with one or more restriction endonucleases in the array processing regions to produce the analyte nucleic acids.

27. The method of claim 18, wherein (c) comprises binding the analyte nucleic acids to the respective regions in which they were generated.

28. The method of claim 18, wherein (c) comprises permitting the analyte nucleic acids to remain in one or more optically confined region of the processing region in which they were generated.

29. The method of claim 18, wherein the analyte nucleic acids are amplified in the processing regions prior to (c).

30. The method of claim 18, wherein analyte nucleic acids in the respective processing or destination regions comprise members with overlapping subsequences.

31. An array of analyte nucleic acids made by the method of claim 18.

32. An array of nucleic acids, comprising: a plurality of nucleic acid analysis regions, each region comprising a group of analyte nucleic acids produced by cleavage of a template nucleic acid, wherein sequences of the analyte nucleic acids correspond to proximal subsequences of a template nucleic acid, wherein the analyte nucleic acids are spatially arranged in the array such that the order of the analyte nucleic acids corresponds to the order of the subsequences in the template nucleic acid.

33. The array of claim 32, wherein the analysis regions are independently selected from: wells, microwells, nanowells, beads, nanobeads, pores, and geographical addresses on a solid support.

34. The array of claim 32, wherein the analysis regions individually comprise one or more optically confined analysis structure.

35. The array of claim 34, wherein the optically confined analysis structure is a zero mode waveguide.

36. An analysis system for sequencing nucleic acids, the system comprising:
an array reader; and,
system instructions that convert signal information received from the array reader into nucleic acid sequence information, wherein said instructions assemble the sequence information into a sequence of interest, wherein assembly of the sequence information into the sequence of interest comprises correlating signal or sequence position information with a sequence region of the sequence of interest.

37. The system of claim 36, wherein the system instructions convert signal information into sequence information for a plurality of nucleic acid analytes that are spatially grouped into regions on an array that is read by the reader, wherein the instructions note the region information for separately grouped analytes, assembling grouped analytes into sequence regions of the sequence of interest.

38. The system of claim 37, comprising an array region approximation module, which module:
arbitrarily defines a set of arbitrary proximity region boundaries for the array;
takes account of analyte nucleic acid sequences from within the arbitrary region boundaries;
assembles sequences of the analyte nucleic acids into contigs;
annotates the array to mark the contig relationships; and,
based upon the contig information, suggests improved region boundaries.
